(19) United States
(12) Patent Application Publication
(10) Pub. No.: US 2010/0238165 A1
(43) Pub. Date: Sep. 23, 2010

(54) GEOSPATIAL MODELING SYSTEM FOR COLORIZING IMAGES AND RELATED METHODS

(75) Inventors: William Watkins, Melbourne Beach, FL (US); Ronald A. Riley, West Melbourne, FL (US); Mark Rahmes, Melbourne, FL (US); Emile Ganthier, Palm Bay, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 12/405,584

(22) Filed: Mar. 17, 2009

(51) Int. Cl. G06T 17/00; G06F 17/50; G06F 19/00

(52) U.S. Cl. 345/420; 703/1; 702/5

(57) ABSTRACT

A geospatial modeling system includes a geospatial model database having stored therein a colorized three-dimensional (3D) model of a geographical area, and a processor cooperating with the geospatial model database. The processor is configured to generate an estimated monochromatic image corresponding to a collected monochromatic image based upon the colorized 3D model, generate a monochromatic difference image between the estimated monochromatic image and the collected monochromatic image, and generate a colorized image corresponding to the collected monochromatic image based upon the monochromatic difference image.

### FIELD OF THE INVENTION

The present invention relates to the field of geospatial modeling, and, more particularly, to colorization of images and related methods.

### BACKGROUND OF THE INVENTION

Topographical models of geographical areas may be used for many applications. For example, topographical models may be used in flight simulators and other planning missions. Furthermore, topographical models of man-made structures, for example, cities, may be extremely helpful in applications, such as, cellular antenna placement, urban planning, disaster preparedness and analysis, and mapping.

Various types of topographical models are presently being used. One common topographical model is a digital elevation model (DEM). The DEM is a sampled matrix representation of a geographical area, which may be generated in an automated fashion by a computer. In the DEM, coordinate points are made to correspond with a height value. DEMs are typically used for modeling terrain where the transitions between different elevations, for example, valleys, mountains, are generally smooth from one to a next. That is, a basic DEM typically models terrain as a plurality of curved surfaces and any discontinuities therebetween are thus “smoothed” over. Another common topographical model is a digital surface model (DSM). The DSM is similar the DEM but may be considered as further including details regarding buildings, vegetation, and roads, in addition to information relating to terrain.

U.S. Pat. No. 6,654,690 to Rahmes et al., which is assigned to the assignee of the present application, and is hereby incorporated herein in its entirety by reference, discloses an automated method for making a topographical model of an area including terrain and buildings thereon based upon randomly spaced data of elevation versus position. The method includes processing the randomly spaced data to generate gridded data of elevation versus position conforming to a predetermined position grid, processing the gridded data to distinguish building data from terrain data, and performing polygon extraction for the building data to make the topographical model of the area including terrain and buildings thereon.

Coloration in images and topographical models may be used to conveniently present additional data to a user. For example, synthetic-aperture radar (SAR) and infrared data can be presented using synthetic color, i.e. false color. More specifically, in these applications, the range of return data is mapped onto a color band, such as in infrared sensor applications, areas of greater return values are typically colored red whereas areas of low return values are typically colored blue.

Nonetheless, true color may be helpful in these applications, in other words, the display coloration is based upon the actual visual electromagnetic spectrum reflective properties of the objects in the topographical model. For example, a field of grass is colored green and a water mass is colored blue. True coloration in topographical models may be advantageous to the user by providing aid in classification and identification of objects in the model.

A potential exemplary application of advantageous true coloration may include the user viewing SAR imagery of an agricultural field with a metallic target therein. The metallic target is an area of high return value (SAR) and is typically falsely colored as white. The agricultural areas around the metallic target are areas of low return values and are typically colored black. The user, when presented with this hypothetical SAR image, cannot accurately evaluate the metallic target's surroundings. In this exemplary application, true coloration would provide the user with valuable context and would present the low return value agricultural areas as green to the user, thereby providing the accurate context and surrounding for the user.

Approaches for providing true coloration for topographical models and images may include, for example, manual techniques, texturing or overlaying true coloration, same-sensor techniques, and false coloration.

### SUMMARY OF THE INVENTION

In view of the foregoing background, it is therefore an object of the present invention to provide a geospatial modeling system that provides colorization for monochromatic imagery.

This and other objects, features, and advantages in accordance with the present invention are provided by a geospatial modeling system comprising a geospatial model database having stored therein a colorized three-dimensional (3D) model of a geographical area, and a processor cooperating with the geospatial model database. The processor is configured to generate an estimated monochromatic image corresponding to a collected monochromatic image based upon the colorized 3D model, generate a monochromatic difference image between the estimated monochromatic image and the collected monochromatic image, and generate a colorized image corresponding to the collected monochromatic image based upon the monochromatic difference image. The colorized image may include, for example, synthetic color and real color. Advantageously, the collected monochromatic image is colorized.

More specifically, the processor may further be configured to generate the colorized image by at least updating the colorized 3D model based upon the monochromatic difference image, generating an estimated colorized image based upon the updated colorized 3D model and corresponding to the collected monochromatic image, and colorizing the collected monochromatic image based upon the estimated colorized image to provide the colorized image.

Additionally, the collected monochromatic image may have collection geometry and sensor characteristics data associated therewith, and the processor may be further configured to generate the estimated monochromatic image based upon the collection geometry and sensor characteristics data.

In some embodiments, the collected monochromatic image may be associated with an area greater than that of the geographical area, and the processor may be further configured to colorize a corresponding portion of the collected monochromatic image. In other embodiments, the collected monochromatic image may be associated with an area equal to or less than the geographical area, and the processor may be further configured to completely colorize the collected monochromatic image.

Furthermore, the geospatial modeling system may further comprise a display coupled to the processor for displaying the colorized image. For example, the colorized 3D model comprises at least one of a digital surface model (DSM), a light detection and ranging (LIDAR) model, and a Shuttle Radar Topography Mission (SRTM) model.

Another aspect is directed to a computer implemented method executed on a geospatial modeling system comprising a geospatial model database storing a colorized 3D model of a geographical area, and a collected monochromatic image for the geographical area, and a processor cooperating with the geospatial model database for generating a colorized image. The method may include using the processor to generate an estimated monochromatic image corresponding to the collected monochromatic image and being based upon the colorized 3D model, using the processor to generate a monochromatic difference image between the estimated monochromatic image and the collected monochromatic image, and using the processor to generate the colorized image corresponding to the collected monochromatic image based upon the monochromatic difference image.

### BRIEF DESCRIPTION OF THE DRAWINGS

FIG. 1 is a schematic diagram of a geospatial modeling system according to the present invention.

FIG. 2 is a more detailed schematic diagram of the geospatial modeling system of FIG. 1.

FIG. 3 is a flowchart illustrating a computer implemented method for geospatial modeling according to the present invention.

FIG. 4 is a schematic block diagram illustrating operation of the geospatial modeling system of FIGS. 1 and 2.

FIG. 5 is a schematic block diagram of a geospatial modeling system according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

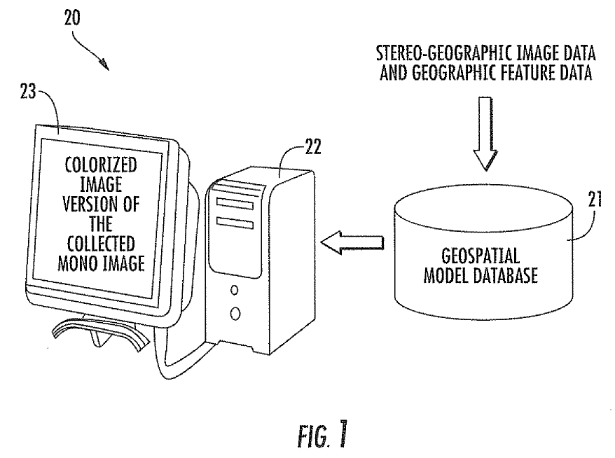

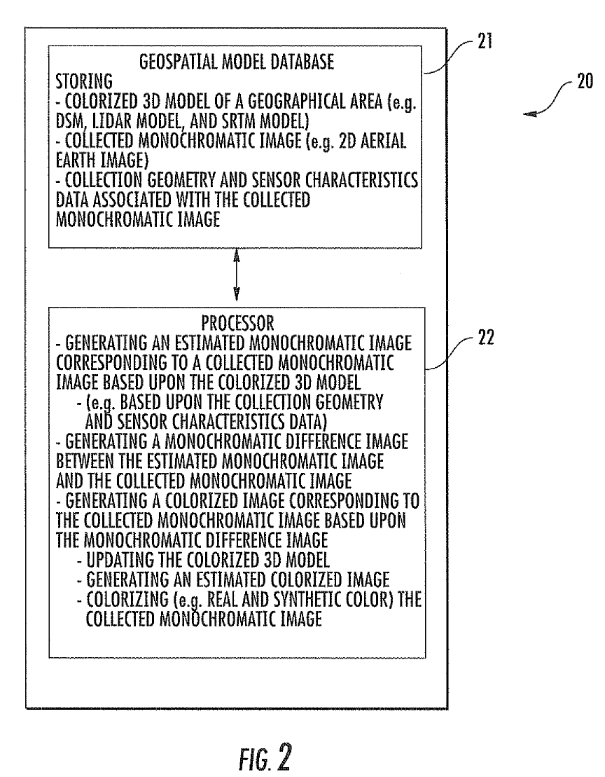

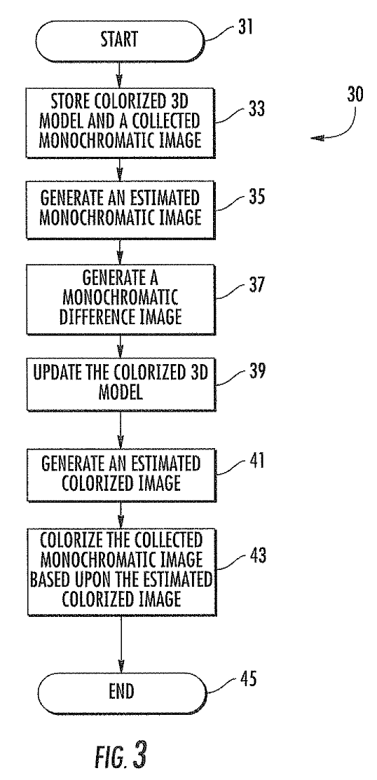

Referring initially to FIGS. 1-3, a geospatial modeling system 20 according to the present invention is now described. Moreover, with reference to the flowchart 30 of FIG. 3, another aspect directed to a computer implemented method for geospatial modeling is also now described, which begins at Block 31. The geospatial modeling system 20 illustratively includes a geospatial model database 21, a processor 22, illustrated as a personal computer (FIG. 1), coupled thereto, and a display 23 also coupled to the processor 22. By way of example, the processor 22 may be a central processing unit (CPU) of a PC, Mac, or other computing workstation.

The geospatial model database 21 illustratively stores at Block 33 a colorized three-dimensional (3D) model of a geographical area. More particularly, the colorized 3D model may comprise a typical 3D model, for example, a digital surface model (DSM), a light detection and ranging (LIDAR) model, a Shuttle Radar Topography Mission (SRTM) model, and a synthetic-aperture radar (SAR) model, and associated colorization data, i.e. data associated with the electromagnetic reflective properties of objects in the 3D model. As will be appreciated by those skilled in the art, the reflective properties may include reflective properties for at least the visible spectrum portion of the electromagnetic spectrum. In some embodiments, the reflective properties may include reflective properties for other portions of the electromagnetic spectrum, for example, infrared and microwave radiation.

The geospatial model database 21 also illustratively stores a collected monochromatic image, for example, grayscale. (Block 33). As will be appreciated by those skilled in the art, the collected monochromatic image may comprise a plurality thereof, for example, optionally being georegistered together in a mosaic image. As also will be appreciated by those skilled in the art, the collected monochromatic image may alternatively be stored in a remote location and accessed remotely or may be collected in real time and simultaneously fed into the processor 22. Additionally, the collected monochromatic image may have collection geometry and sensor characteristics data associated therewith, for example, locational data, field of view, etc. The collected monochromatic image may comprise a synthetic aperture radar image or a two-dimensional (2D) aerial earth image, for example.

The processor 22 cooperates with the geospatial database 21 and is configured perform certain tasks. As will be appreciated by those skilled in the art, this may be facilitated using firmware embedded on the processor 22 or with software stored on a separate memory device (not shown). As illustrated, the processor 22 is configured to generate an estimated monochromatic image at Block 35 corresponding to the collected monochromatic image based upon the colorized 3D model. In other words, the processor 22 uses the 3D model data to replicate the collected monochromatic image, more specifically, based upon the collection geometry and sensor characteristics data.

Furthermore, at Block 37, the processor 22 is configured to generate a monochromatic difference image between the estimated monochromatic image and the collected monochromatic image. In this step, the processor 22 provides a user with information relating to objects that have changed in the collected monochromatic image. For example, if a mobile target has recently moved into the geographical area, the collected monochromatic image, which is likely more recent than the colorized 3D model, would include the mobile target but the estimated monochromatic image would not include this target.

At Block 39, the processor 22 is configured to update the colorized 3D model based upon the monochromatic difference image. In other words, the monochromatic difference image is used to update the colorized 3D model, for example, by placing the aforementioned mobile target in the colorized 3D model.

The processor 22 is further configured at Block 41 to generate an estimated colorized image based upon the updated colorized 3D model and corresponding to the collected monochromatic image. As will be appreciated by those skilled in the art, this estimated colorized image comprises normalized color data, i.e. it is devoid of intensity data and includes only reflective color response.

The processor 22 is further configured at Block 43 to colorize the collected monochromatic image based upon the estimated colorized image to provide the colorized image. In other words, the processor 22 is configured to generate a colorized image corresponding to the collected monochromatic image based upon the monochromatic difference image. As will be appreciated by those skilled in the art, the colorized image may include, for example, synthetic color and real/true color. The geospatial modeling system 20 outputs the colorized image on the display 23 for viewing by the user. The method ends at Block 45.

Advantageously, the colorized image comprises a data fusion between the original collected monochromatic image and the colorization data. In other words, the colorization data is not “burned” into the collected monochromatic image. Accordingly, the user can independently view the information of the collected monochromatic image, for example, SAR return data, and the colorization data provided by the method described herein.

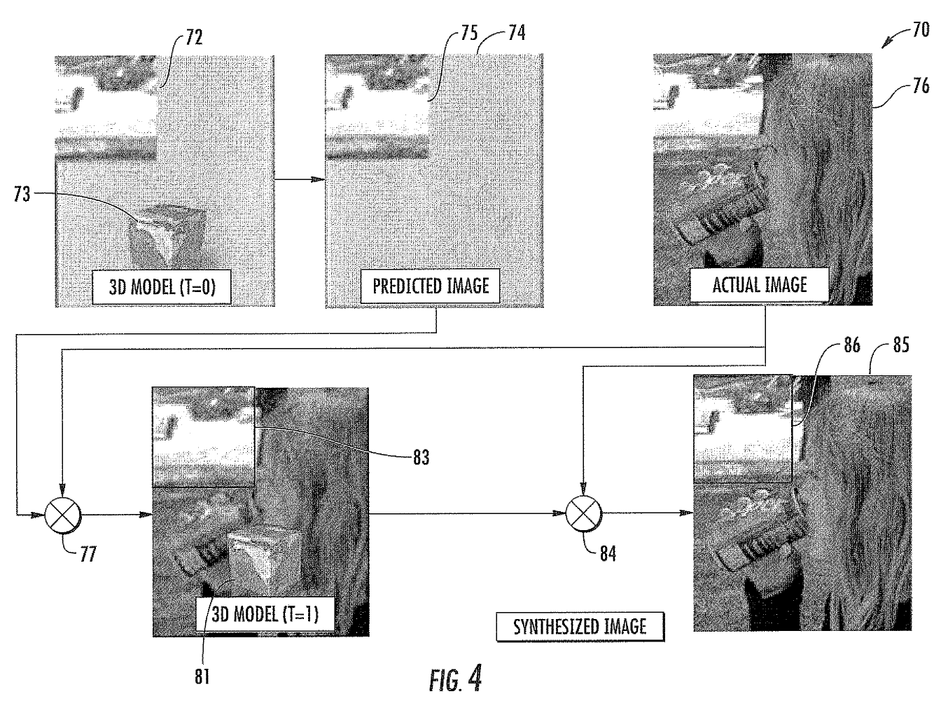

Referring briefly to FIG. 4, a diagram 70 illustrates operation of certain embodiments of the geospatial modeling system 20 described above. In these embodiments, the collected monochromatic image 76 is associated with an area greater than that of the geographical area 72 covered by the colorized 3D model 73. In other words, in these embodiments, the colorized 3D model 73 is incomplete and covers only a portion of the collected monochromatic image 76. Accordingly, the estimated monochromatic image 74 also covers only a corresponding portion 75. Downstream, the collected monochromatic image 76 and the estimated monochromatic image 74 are combined at a first combiner 77. As will be appreciated by those skilled in the art, the updated colorized 3D model 81 may cover an extended geographical area beyond the corresponding portion 83 for the incomplete colorized 3D model 73. The 3D model data may be extended using the collected monochromatic image, for example, by using stereographic techniques to extend the incomplete 3D model 73. Nonetheless, downstream from a second combiner 84, the associated colorization data cannot be similarly extended since the collected image 76 is monochromatic, i.e. only a portion 86 of the final colorized image 85 is actually colorized. For ease of explanation and reproduction, the drawings are in grayscale, but those skilled in the art will readily appreciate what the colorized version would look like.

In other words, in these embodiments, the processor 22 may be further configured to colorize a corresponding portion of the collected monochromatic image 76. Alternatively, the processor 22 may interpolate the colorization data to extend beyond the corresponding portion of the collected monochromatic image.

Additionally, in this illustration, the resolution of the colorized 3D model 73 is lower than the resolution of the collected monochromatic image 76. The illustrated estimated monochromatic image 74 also has a corresponding lower resolution than the collected monochromatic image 76. Nonetheless, this geospatial modeling system 20 extracts the useful coloration information from the colorized 3D model 73 and applies it to the corresponding portion of the collected monochromatic image 76. Of course, this geospatial modeling system 20 can be ingest with varying colorized 3D model-collected monochromatic image resolution ratios, for example, where the colorized 3D model 73 has greater resolution than the collected monochromatic image 76 (not shown).

In other embodiments, the collected monochromatic image may be associated with an area equal to or less than the geographical area. In other words, in these embodiments, the colorized 3D model is complete and covers the entirety of the collected monochromatic image. Further, in these embodiments, the processor 22 may be further configured to completely colorize the collected monochromatic image.

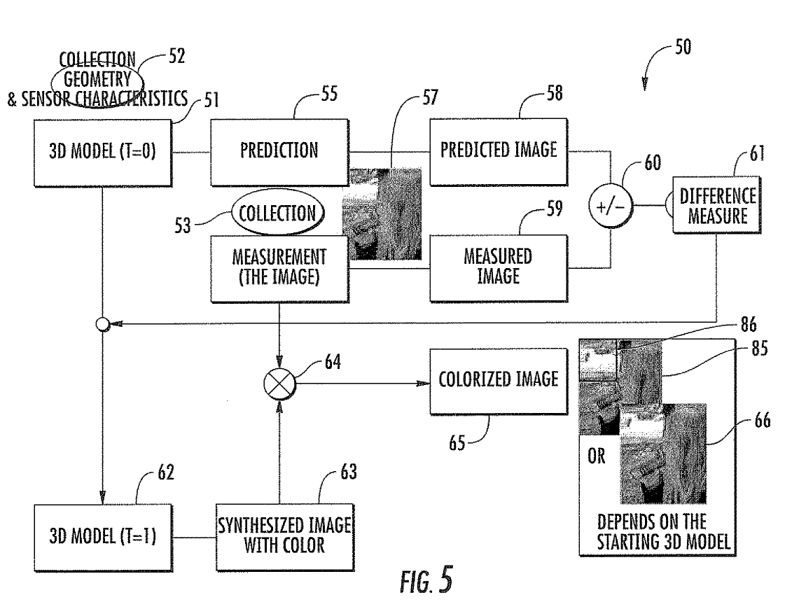

Referring additionally to FIG. 5, as will be appreciated by those skilled in the art, an exemplary implementation 50 of the geospatial modeling system 20 is now further described. The exemplary implementation 50 of the geospatial modeling system illustratively ingests the collection geometry 52 at a 3D model module 51 and ingests the collection 53 of images 57 at a measurement module 53. This geospatial modeling system 50 illustratively includes a prediction module 55 downstream from the 3D model module 51, and a predicted image module 58 downstream from the prediction module. This geospatial modeling system 50 also illustratively includes a measured image module 59 downstream from the collection 53 ingest, and a difference module 60 downstream from the predicted image module 58 and the measured image module to provide the monochromatic difference image.

This geospatial modeling system 50 illustratively includes an updating module 62 downstream from the difference module 60 for updating the colorized 3D model based upon the monochromatic difference image, a synthetic colorized image module 63 downstream from the updating module, and a combiner module 64 downstream from the collection 53 of images and the synthetic colorized image module. The geospatial modeling system 50 also illustratively includes a colorized image module 65 for providing the colorized images 66, 85 (having either complete colorization image 66 or partial colorization image 85 with corresponding colorized portion 86). For ease of explanation and reproduction, the drawings are in grayscale, but those skilled in the art will readily appreciate what the colorized version would look like.

The above described geospatial system may be used in conjunction with a geospatial modeling system described in co-pending application titled “GEOSPATIAL MODELING SYSTEM FOR REDUCING SHADOWS AND OTHER OBSCURATION ARTIFACTS AND RELATED METHODS,” having Attorney Docket No. 50691, which is hereby incorporated herein in its entirety by reference.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A geospatial modeling system comprising:
a geospatial model database having stored therein a colorized three-dimensional (3D) model of a geographical area; and
a processor cooperating with said geospatial model database and configured to
generate an estimated monochromatic image corresponding to a collected monochromatic image based upon the colorized 3D model,
generate a monochromatic difference image between the estimated monochromatic image and the collected monochromatic image, and
generate a colorized image corresponding to the collected monochromatic image based upon the monochromatic difference image.

2. The geospatial modeling system according to claim 1 wherein said processor is further configured to generate the colorized image by at least:
updating the colorized 3D model based upon the monochromatic difference image;
generating an estimated colorized image based upon the updated colorized 3D model and corresponding to the collected monochromatic image; and
colorizing the collected monochromatic image based upon the estimated colorized image to provide the colorized image.

3. The geospatial modeling system according to claim 1 wherein the colorized image includes synthetic color and real color.

4. The geospatial modeling system according to claim 1 wherein the collected monochromatic image has collection geometry and sensor characteristics data associated therewith; and wherein said processor is further configured to generate the estimated monochromatic image based upon the collection geometry and sensor characteristics data.

5. The geospatial modeling system according to claim 1 wherein the collected monochromatic image is associated with an area greater than that of the geographical area; and wherein said processor is further configured to colorize a corresponding portion of the collected monochromatic image.

6. The geospatial modeling system according to claim 1 wherein the collected monochromatic image is associated with an area equal to or less than the geographical area; and wherein said processor is further configured to completely colorize the collected monochromatic image.

7. The geospatial modeling system according to claim 1 further comprising a display coupled to said processor for displaying the colorized image.

8. The geospatial modeling system according to claim 1 wherein the colorized 3D model comprises at least one of a digital surface model (DSM), a light detection and ranging (LIDAR) model, and a Shuttle Radar Topography Mission (SRTM) model.

9. A geospatial modeling system comprising:
a geospatial model database having stored therein a colorized three-dimensional (3D) model of a geographical area; and
a processor cooperating with said geospatial model database and configured to
generate an estimated monochromatic image corresponding to a collected monochromatic image based upon the colorized 3D model and collection geometry and sensor characteristics data associated with the collected monochromatic image,
generate a monochromatic difference image between the estimated monochromatic image and the collected monochromatic image,
update the colorized 3D model based upon the monochromatic difference image,
generate an estimated colorized image based upon the updated colorized 3D model and corresponding to the collected monochromatic image, and
generate a colorized image corresponding to the collected monochromatic image and being based upon the estimated colorized image.

10. The geospatial modeling system according to claim 9 wherein the colorized image includes synthetic color and real color.

11. The geospatial modeling system according to claim 9 wherein the collected monochromatic image is associated with an area greater than that of the geographical area; and wherein said processor is further configured to colorize a corresponding portion of the collected monochromatic image.

12. The geospatial modeling system according to claim 9 wherein the collected monochromatic image is associated with an area equal to or less than the geographical area; and wherein said processor is further configured to completely colorize the collected monochromatic image.

13. The geospatial modeling system according to claim 9 further comprising a display coupled to said processor for displaying the colorized image.

14. The geospatial modeling system according to claim 9 wherein the colorized 3D model comprises at least one of a digital surface model (DSM), a light detection and ranging (LIDAR) model, and a Shuttle Radar Topography Mission (SRTM) model.

15. A computer implemented method executed on a geospatial modeling system comprising a geospatial model database storing a colorized three-dimensional (3D) model of a geographical area, and a collected monochromatic image for the geographical area, and a processor cooperating with the geospatial model database for generating a colorized image, the method comprising:
using the processor to generate an estimated monochromatic image corresponding to the collected monochromatic image and being based upon the colorized 3D model;
using the processor to generate a monochromatic difference image between the estimated monochromatic image and the collected monochromatic image; and
using the processor to generate the colorized image corresponding to the collected monochromatic image and being based upon the monochromatic difference image.

16. The computer implemented method according to claim 15 wherein the generating of the colorized image comprises:
updating the colorized 3D model based upon the monochromatic difference image;
generating an estimated colorized image based upon the updated colorized 3D model and corresponding to the collected monochromatic image; and
colorizing the collected monochromatic image based upon the estimated colorized image to provide the colorized image.

17. The computer implemented method according to claim 15 wherein the colorized image includes synthetic color and real color.

18. The computer implemented method according to claim 15 wherein the collected monochromatic image has collection geometry and sensor characteristics data associated therewith; and wherein generating the estimated monochromatic image is based upon the collection geometry and sensor characteristics data.

19. The computer implemented method according to claim 15 wherein the collected monochromatic image is associated with an area greater than that of the geographical area; and wherein the colorized image corresponds to a portion of the collected monochromatic image.

20. The computer implemented method according to claim 15 wherein the collected monochromatic image is associated with an area equal to or less than the geographical area; and wherein the generating of the colorized image comprises completely colorizing the collected monochromatic image.

21. The computer implemented method according to claim 15 further comprising displaying the colorized image.
